(19) United States
(12) Patent Application Publication
(10) Pub. No.: US 2009/0172576 A1
(43) Pub. Date: Jul. 2, 2009

(54) Method and System for Enabling and Disabling Features of a Computer Application Using a Preview Mode Within a Graphical User Interface

(76) Inventor: Nixon Cheaz, Cary, NC (US)

Correspondence Address: DILLON & YUDELL LLP, 8911 N. CAPITAL OF TEXAS HWY., SUITE 2110, AUSTIN, TX, 78759, US

(21) Appl. No.: 11/966,523

(22) Filed: Dec. 28, 2007

(51) Int. Cl. G06F 3/048

(52) U.S. Cl. 715/765

(57) ABSTRACT

A method, system and computer program product are disclosed for enabling and disabling features of a computer application using a capabilities preview mode within a graphical user interface element of the computer application. In one embodiment, the method includes displaying a graphical user interface element in a capabilities preview mode to a user of an application of a data processing system. The capabilities preview mode causes the graphical user interface element to be displayed with an indication of a feature of the computer application that is capable of being enabled and disabled by the user. The capabilities preview mode also causes the indication of the feature to be displayed at a location within the graphical user interface element where the feature is accessed by the user when the feature is enabled and the graphical user interface is not being displayed in the capabilities preview mode.

### BACKGROUND OF THE INVENTION

The present invention relates in general to the field of computers and computer systems, and in particular to computer applications with extensible features.

Many modern computer applications provide built-in extensibility and reusability frameworks to support the addition and removal of optional functionality at run time. These extra units of functionality are commonly called “add-ins”, “plug-ins”, “features”, etc. The extra units of functionality are usually in the form of binary components that can be added or removed dynamically from the mail application by way of a very well defined extensibility framework. Examples of this type of computer application include the Eclipse rich client platform (RCP) or Firefox® by Mozilla.

For large and successful computer applications such as Eclipse, the large number of plug-ins and features available to a user can be overwhelming. There is typically a need to manage (e.g. enable or disable) the plug-ins to conserve system resources. However, managing such a large number of available plug-ins is a non-trivial task.

A common way of managing plug-ins for extensible computer applications is for the user to access a dialog box that shows a list of “capabilities” available for the computer application. The user may then enable and disable the capabilities listed by name. A problem with this approach is that if the list of capabilities is very large, the user is left to guess which capability maps to the features of the computer application that the user would like to enable or disable. The user sees a long list of plug-in names, but may not be familiar with how each named plug-in functions within the computer application.

For example, in the Rationale Application Deveoper (RAD) version 6 integrated development environment (IDE) by IBM Corporation, there is a plug-in that provides a feature for creating a web service by using a right mouse click context menu on a Java™ class (Web Services—Create Web Service). The plug-in is not enabled by default, however a user may be familiar with the featured provided by the plug-in, having used a different RAD IDE installation with the feature enable on another computer. The user knows how the access feature within the user interface an RAD IDE that has the feature is enabled (e.g., by right-clicking on a Java™ class), but does not find the feature available in the particular RAD installation that does not have the feature enabled. To enable the feature, the user must know to access the “Capabilities” dialog box and will have to figure out which one capability among the listed capabilities will enable the desired feature. Finding the right capability to enable is not always obvious, and the user may end up having to consult a help resource or calling technical support agent.

### BRIEF SUMMARY OF THE INVENTION

The present invention provides a method, system and computer program product for enabling and disabling features of a computer application using a capabilities preview mode within a graphical user interface element of the computer application. In one embodiment, the method includes displaying a graphical user interface element in a capabilities preview mode to a user of an application of a data processing system. The capabilities preview mode causes the graphical user interface element to be displayed with an indication of a feature of the computer application that is capable of being enabled and disabled by the user. The capabilities preview mode also causes the indication of the feature to be displayed at a location within the graphical user interface element where the feature is accessed by the user when the feature is enabled and the graphical user interface is not being displayed in the capabilities preview mode.

The above, as well as additional purposes, features, and advantages of the present invention will become apparent in the following detailed written description.

### BRIEF DESCRIPTION OF THE SEVERAL VIEWS OF THE DRAWINGS

The novel features believed characteristic of the invention are set forth in the appended claims. The invention itself, however, as well as a best mode of use, further purposes and advantages thereof, will best be understood by reference to the following detailed description of an illustrative embodiment when read in conjunction with the accompanying drawings, where:

FIG. 1 is a block diagram of an exemplary data processing system in which the present invention may be implemented;

FIG. 2 shows a diagram of exemplary application window 146 in which one or more embodiments of the present invention can be implemented;

FIG. 3 shows a diagram of exemplary application window 146 in capabilities preview mode;

FIG. 4 shows a diagram of exemplary application window 146 after enabling a feature using capabilities preview mode;

FIG. 5 shows an exemplary application window 146 in capabilities preview mode with contextual menu 504 displayed;

FIG. 6 shows flowchart 600 which demonstrates an exemplary method for implementing one or more embodiments of the present invention.

### DETAILED DESCRIPTION OF THE INVENTION

An illustrative embodiment of the present invention is directed to a method, system and computer-readable medium for enabling and disabling feature of a computer application using a capabilities preview mode within a graphical user interface element of the computer application. The present invention can take the form of an entirely hardware embodiment, an entirely software embodiment or an embodiment containing both hardware and software elements. In an illustrative embodiment, the invention is implemented in software, which includes, but is not limited to, firmware, resident software, microcode, etc.

Furthermore, the invention can take the form of a computer program product accessible from a computer-usable or computer-readable medium providing program code for use by or in connection with a computer or any instruction execution system. For the purposes of this description, a computer-usable or computer-readable medium can be any apparatus that can contain, store, communicate, propagate, or transport the program for use by or in connection with the instruction execution system, apparatus or device.

The medium can be an electronic, magnetic, optical, electromagnetic, infrared or semiconductor system, apparatus or device or a propagation medium. Examples of a computer-readable medium include a semiconductor or solid state memory (e.g., flash drive memory), magnetic tape, a removable computer diskette, a random access memory (RAM), a read-only memory (ROM), a rigid magnetic disk (e.g., a hard drive) and an optical disk. Current examples of optical disks include compact disk-read only memory (CD-ROM), compact disk-read/write (CD-R/W) and Digital Versatile Disk (DVD).

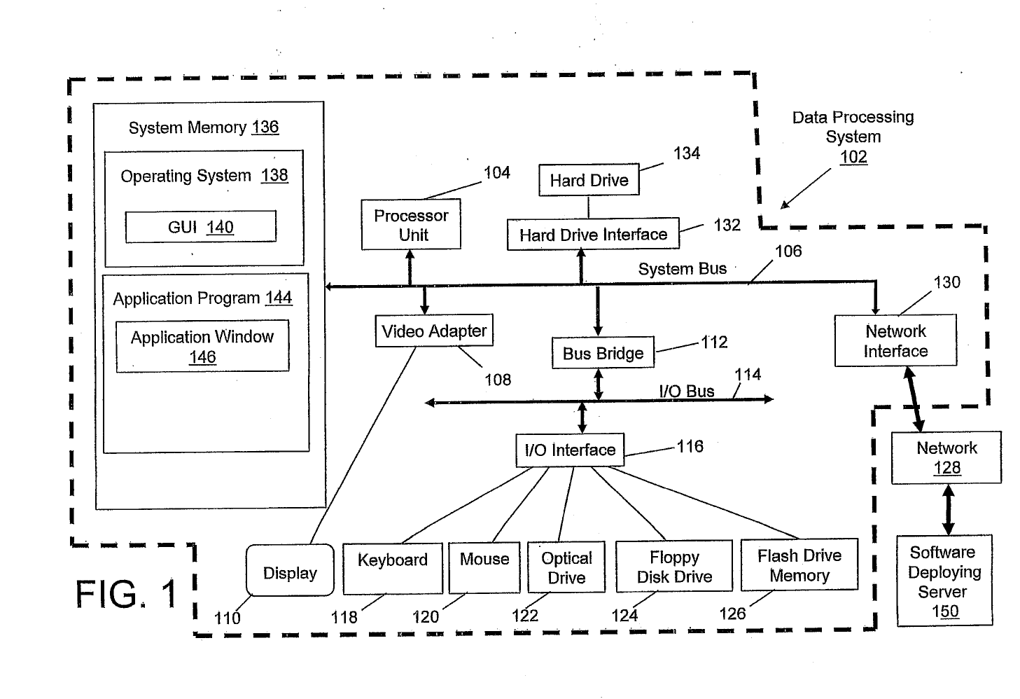

Referring now to the drawings, wherein like numbers denote like parts throughout the several views, FIG. 1 shows a block diagram of a data processing system suitable for storing and/or executing program code in accordance with one or more embodiments of the present invention. Data processing system 102 includes a processor unit 104 that is coupled to a system bus 106. A video adapter 108, which drives/supports a display 110, is also coupled to system bus 106. System bus 106 is coupled via a bus bridge 112 to an Input/Output (I/O) bus 114. An I/O interface 116 is coupled to I/O bus 114. I/O interface 116 affords communication with various I/O devices, including a keyboard 118, a mouse 120, an optical disk drive 122, a floppy disk drive 124, and a flash drive memory 126. The format of the ports connected to I/O interface 116 may be any known to those skilled in the art of computer architecture, including but not limited to Universal Serial Bus (USB) ports.

Data processing system 102 is able to communicate with a software deploying server 150 via a network 128 using a network interface 130, which is coupled to system bus 106. Network 128 may be an external network such as the Internet, or an internal network such as an Ethernet or a Virtual Private Network (VPN). Software deploying server 150 may utilize a similar architecture design as that described for data processing system 102.

A hard drive interface 132 is also coupled to system bus 106. Hard drive interface 132 interfaces with hard drive 134. In a preferred embodiment, hard drive 134 populates a system memory 136, which is also coupled to system bus 106. Data that populates system memory 136 includes an operating system (OS) 138 of data processing system 102 and application programs 144.

OS 138 (e.g., UNIX®, Windows®) is a set of computer programs that manage the hardware and software resources of data processing system 102, including memory management, process and task management, disk management, and mouse and keyboard management. OS 138 includes a graphical user interface (GUI) 140 for providing user access to resources such as system settings, files stored in memory, and application programs, such as application program 144. Application program 144 is also presented to a user in a graphical format via application window 146. A user utilizes an input device such as mouse 120 to interact with the graphical elements of GUI 140 and application window 146.

The hardware elements depicted in data processing system 102 are not intended to be exhaustive, but rather are representative to highlight essential components required by the present invention. For instance, data processing system 102 may include alternate memory storage devices such as magnetic cassettes, Digital Versatile Disks (DVDs), Bernoulli cartridges, and the like. These and other variations are intended to be within the spirit and scope of the present invention.

Note further that, in one embodiment of the present invention, software deploying server 150 performs all of the functions associated with the present invention (including execution of application program 144), thus freeing data processing system 102 from having to use its own internal computing resources to execute application program 144.

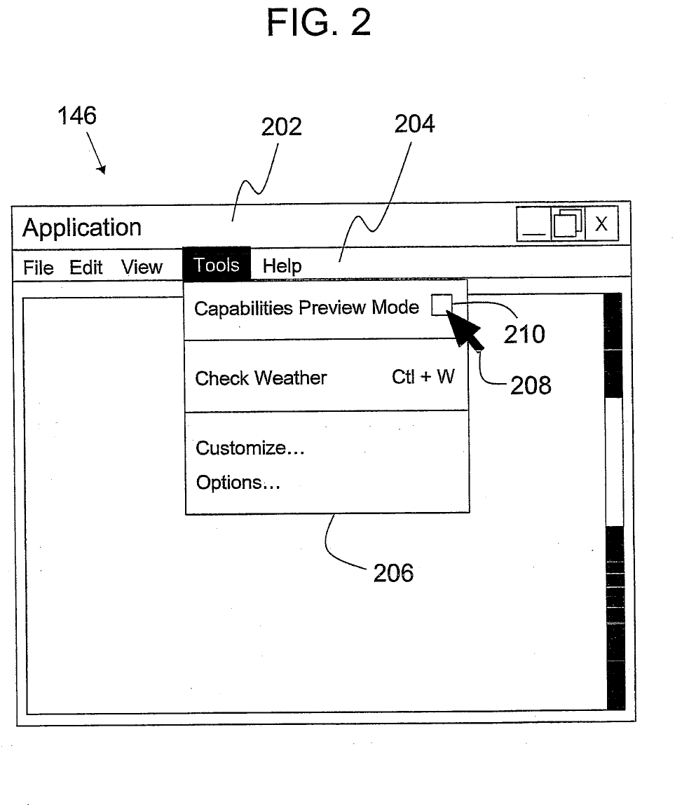

With reference now to FIG. 2, a diagram of exemplary application window 146 is shown in which one or more embodiments of the present invention can be implemented. While application window 146 is used for purposes of illustration, the present invention can be utilized with other aspects of GUI 140 and is not limited to an application window and the elements displayed therein. Application window 146 comprises common graphical user interface elements such as title bar 202, menu bar 204 and dropdown menu 206. Title bar 201 displays the title of the application and/or the filename of a file that is being edited. Menu bar 202 displays menu titles such as “File”, “Edit”, “View”, “Tools” and “Help”. Dropdown menu 206 is displayed when a user positions a pointer 208 over a menu title with an input device, such as mouse 120, and presses a button while pointer 208 is positioned over a menu title, such as “Tools”. A user may use mouse 120 to select a command from dropdown menu 206. Dropdown menu 206 displays a list of commands from which a user may select a command with mouse 120. Some commands are built-in to the base application, such as “Customize” or “Options”. Other commands are made available by enabling an application feature provided by a plug-in, such as “Check Weather”.

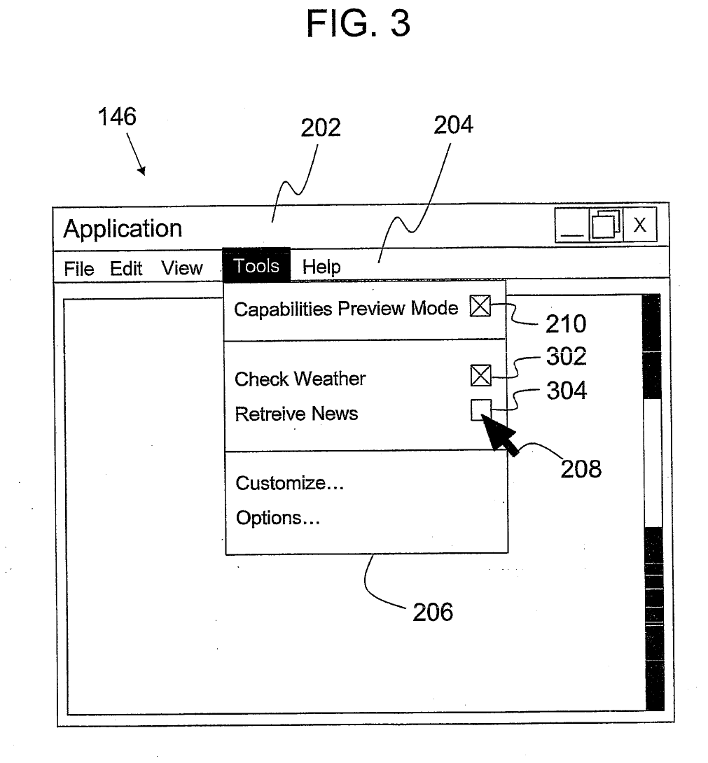

The “Capabilities Preview Mode” command enables a user to place application program 144 in capabilities preview mode by selecting, for example, checkbox 210. A user may be familiar with a feature that is enabled in a particular installation of application program 144 (for example, on a different data processing system), but is not enabled on the installation of application program 144 that the user is currently using. Capability preview mode displays the feature where it would normally appear in a graphical user interface element if the feature were enabled, enabling the user to quickly enable a disabled feature (and vice-versa) by looking in a location that is known to the user. For example, a user would like to use a “Retrieve News” feature that the user accesses by dropdown menu 206. But the “Retrieve News” feature is not shown in dropdown menu 206 in the particular installation of application program 144 shown in FIG. 2. The user can select checkbox 210 to place application program in capabilities preview mode, as shown in FIG. 3.

FIG. 3 shows a diagram of exemplary application window 146 in capabilities preview mode. When application program 144 is in capabilities preview mode, a graphical user interface element is displayed showing all features that would in available if all of the installed capabilities were enabled. In one embodiment, the features are not functional until the user toggles out of capabilities preview mode. Capabilities preview mode enables the user to enable or disable a feature. For example, in FIG. 3 dropdown menu 206 is displayed in capabilities preview mode due to checkbox 210 being selected. Built-in commands “Customize” and “Options” are displayed without checkboxes, since those features are provided by the base application and are not extensible feature provided by a plug-in. Extensible feature “Check Weather” is provided by an installed plug-in and is displayed with checkbox 302. By selecting or deselecting checkbox 302, the user can respectively enable or disable the “Check Weather” feature. The “Retrieve News” feature is displayed within dropdown menu 206 at the location where the feature would appear if it were enabled when application program 144 is not in capabilities preview mode. By selecting or deselecting checkbox 304, the user can respectively enable or disable the “Retrieve News” feature. In one embodiment, the user can place pointer 208 over the “Retrieve News” feature to display (for example in a hover window) the name of the capability or plug-in that provides the “Retrieve News” feature.

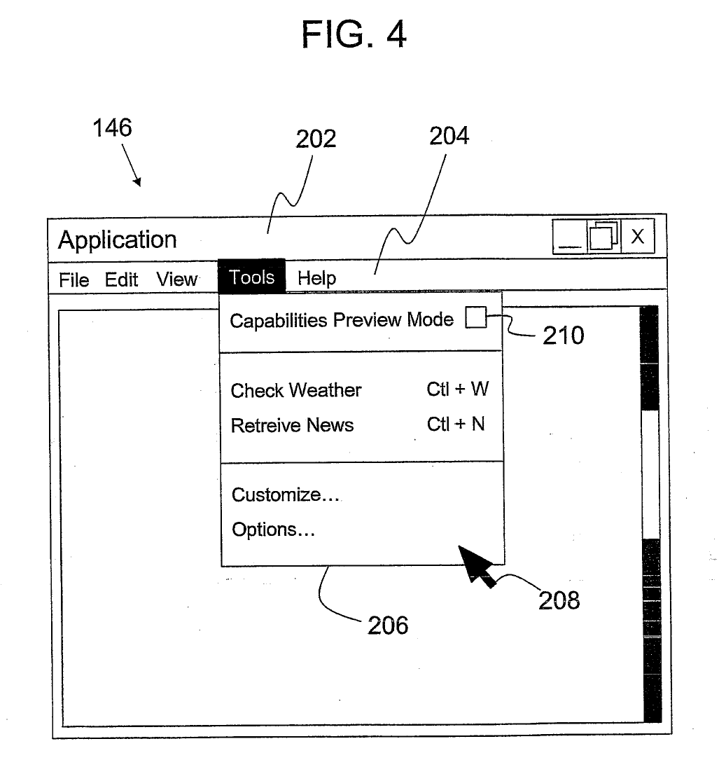

FIG. 4 shows a diagram of exemplary application window 146 after enabling a feature using capabilities preview mode. The user toggles out of capabilities preview mode by deselecting checkbox 210. The “Retrieve News” feature, which was enabled in capabilities preview mode as described above in reference to FIG. 3, is now displayed in dropdown menu 206. The “Retrieve News” feature is now available for selection by the user.

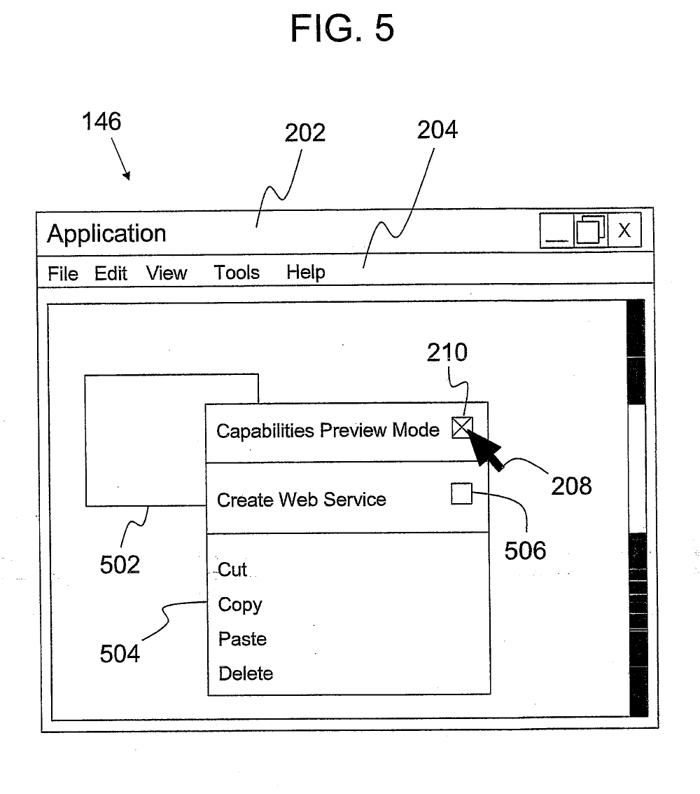

While an exemplary embodiment has been described with reference to dropdown menu 206, the present invention can be used with any graphical user interface element suitable for being displayed in a capabilities preview mode and is not limited to dropdown menus such as dropdown menu 206. With reference now to FIG. 5, an exemplary application window 146 is again shown in capabilities preview mode with contextual menu 504 displayed. The exemplary graphical user interface element in FIG. 5 is a contextual menu, which is typically displayed in response to a user performing an alternate input device action (e.g., right mouse click) on object 502 in application window 146. The “Create Web Service” feature is made available to the user in contextual menu 504 and may be enabled or disabled by respectively selecting or deselecting checkbox 506.

While an exemplary embodiment has been described using checkboxes, it will be understood by one skilled in the art that alternative means of selecting feature may be used without departing from the spirit and scope of the invention. For example, radio boxes can be used instead of check boxes. Alternatively, extensible features can be displayed in capabilities preview mode as highlighted, bolded or in a different color, and selecting the feature toggles whether the feature is enabled or disabled.

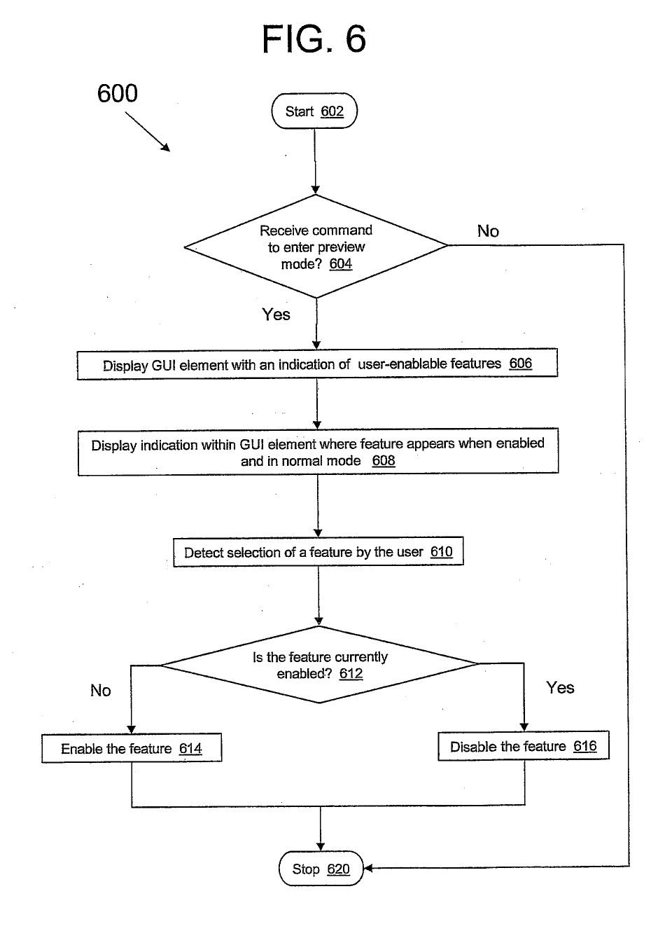

FIG. 6 shows flowchart 600 which demonstrates an exemplary method for implementing one or more embodiments of the present invention. The process starts at initiator 602. Application program 144 determines whether the user has issued; a command for the application program to enter capabilities preview mode (step 604). If the command has not been received, the process stops at terminator 620. If the command has been received, a graphical user interface element is displayed to the user with an indication of a feature of application program 144 that is capable of being enabled and disabled by the user (step 606). The indication is displayed to the user at a location within the graphical user interface element whether the feature is accessed by the user when the feature is enabled and the graphical user interface element is not being displayed in capabilities preview mode (step 608). Application program 144 detects a selection of a feature by the user (step 610) and determines whether the feature is currently enabled or disabled within application program 144 (step 612). If the feature is currently disabled, application program 144 enables the feature (step 614) and the process ends at terminator 620. If the feature is currently enabled, application program 144 disables the feature (step 616) and the process ends at terminator 620. While the method of flowchart 600 has been described with step being performed by application program 144, it will be understood by one skilled in that art that those steps can also be performed by other computer executable code responsible for displaying graphical user interface items, such as a different application program, a computer application framework (such as Eclipse) or operating system 138.

While the present invention has been particularly shown and described with reference to an illustrative embodiment, it will be understood by those skilled in the art that various changes in form and detail may be made therein without departing from the spirit and scope of the invention. Furthermore, as used in the specification and the appended claims, the term “computer” or “computer system” or “computing device” includes any data processing system including, but not limited to, personal computers, servers, workstations, network computers, mainframe computers, routers, switches, Personal Digital Assistants (PDA's), telephones, and any other system capable of processing, transmitting, receiving, capturing and/or storing data. The term “system” or “information system” includes a network of data processing systems.

The flowchart and diagrams in the Figures illustrate the architecture, functionality, and operation of possible implementations of systems, methods and computer program products according to various embodiments of the present invention. In this regard, each block in the flowchart or diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

Having thus described the invention of the present application in detail and by reference to illustrative embodiments thereof, it will be apparent that modifications and variations are possible without departing from the scope of the invention defined in the appended claims.

What is claimed is:

1. A method in a data processing system comprising:
displaying a graphical user interface element in a capabilities preview mode to a user of an application of a data processing system;
wherein said capabilities preview mode causes the graphical user interface element to be displayed with an indication of a feature of the computer application that is capable of being enabled and disabled by the user; and
wherein said capabilities preview mode causes said indication of the feature to be displayed at a location within the graphical user interface element where the feature is accessed by the user when said feature is enabled and the graphical user interface is not being displayed in said capabilities preview mode.

2. The method of claim 1, further comprising:
detecting a selection of said feature by the user;
determining whether said feature is enabled;
in response to determining that said feature is enabled, automatically disabling said feature; and
in response to determining that said feature is not enabled, automatically enabling said feature.

3. The method of claim 1, wherein said displaying the graphical user interface element in the capabilities preview mode is performed in response to receiving a command from the user.

4. The method of claim 1, wherein the graphical user interface element is a dropdown menu.

5. The method of claim 1, wherein the graphical user interface element is a contextual menu.

6. The method of claim 1, wherein said indication of the feature identifies a plug-in that provides the feature to the computer application.

7. The method of claim 1, wherein said indication of the feature is visually distinct from indications of features that are not capable of being enabled and disabled by the user.

8. A data processing system comprising:
a processor;
a memory coupled to said processor;
means for displaying a graphical user interface element in a capabilities preview mode to a user of an application of a data processing system;
wherein said capabilities preview mode causes the graphical user interface element to be displayed with an indication of a feature of the computer application that is capable of being enabled and disabled by the user; and
wherein said capabilities preview mode causes said indication of the feature to be displayed at a location within the graphical user interface element where the feature is accessed by the user when said feature is enabled and the graphical user interface is not being displayed in said capabilities preview mode.

9. The data processing system of claim 8, further comprising:
means for detecting a selection of said feature by the user;
means for determining whether said feature is enabled;
means, responsive to determining that said feature is enabled, for automatically disabling said feature; and
means, responsive to determining that said feature is not enabled, for automatically enabling said feature.

10. The data processing system of claim 8, wherein said means for displaying the graphical user interface element in the capabilities preview mode is responsive to receiving a command from the user.

11. The data processing system of claim 8, wherein the graphical user interface element is a dropdown menu.

12. The data processing system of claim 8, wherein the graphical user interface element is a contextual menu.

13. The data processing system of claim 8, wherein said indication of the feature identifies a plug-in that provides the feature to the computer application.

14. The data processing system of claim 8, wherein said indication of the feature is visually distinct from indications of features that are not capable of being enabled and disabled by the user.

15. A computer program product comprising:
a computer-readable medium, said computer-readable medium encoded with a computer program that, when executed, causes control circuitry to perform the steps of:
displaying a graphical user interface element in a capabilities preview mode to a user of an application of a data processing system;
wherein said capabilities preview mode causes the graphical user interface element to be displayed with an indication of a feature of the computer application that is capable of being enabled and disabled by the user; and
wherein said capabilities preview mode causes said indication of the feature to be displayed at a location within the graphical user interface element where the feature is accessed by the user when said feature is enabled and the graphical user interface is not being displayed in said capabilities preview mode.

16. The computer program product of claim 15, further comprising:
detecting a selection of said feature by the user;
determining whether said feature is enabled;
in response to determining that said feature is enabled, automatically disabling said feature; and
in response to determining that said feature is not enabled, automatically enabling said feature.

17. The computer program product of claim 15, wherein said displaying the graphical user interface element in the capabilities preview mode is performed in response to receiving a command from the user.

18. The computer program product of claim 15, wherein the graphical user interface element is a dropdown menu.

19. The computer program product of claim 15, wherein the graphical user interface element is a contextual menu.

20. The computer program product of claim 15, wherein said indication of the feature is visually distinct from indications of features that are not capable of being enabled and disabled by the user.
